(19) United States
(12) Patent Application Publication
(10) Pub. No.: US 2010/0208094 A1
(43) Pub. Date: Aug. 19, 2010

(54) IMAGING APPARATUS, METHOD FOR SETTING CONTINUOUS SHOOTING SPEED, AND STORAGE MEDIUM

(75) Inventor: Jun IIJIMA, Tokorozawa-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 12/703,957

(22) Filed: Feb. 11, 2010

(30) Foreign Application Priority Data
Feb. 13, 2009 (JP) 2009-030714

(51) Int. Cl. H04N 5/228

(52) U.S. Cl. 348/222.1; 348/E05.031

(57) ABSTRACT

An imaging apparatus, including: an imaging section for generating image data by performing continuous shooting, a first setting section for setting the number of images to be photographed, in each of the images a subject image is to be included; a dividing section for dividing a photographing region of the imaging section into divided regions of the number of images set by the first setting section; a second setting section for setting a continuous shooting speed based on a photographed position of the subject image in each of the divided regions divided by the dividing section; and a controller for controlling the imaging section to perform the continuous shooting at the continuous shooting speed set by the second setting section.

### BACKGROUND OF THE INVENTION

1. Field of the Invention

The present invention relates to an imaging apparatus, a method for setting a continuous shooting speed, and a storage medium.

2. Related Art

Heretofore, an imaging apparatus with a function of continuous shooting becomes widely used.

In recent years, according to an improvement of imaging devices, an imaging apparatus, in which continuous shooting speed is changed corresponding to an angle of view (cropped area), is disclosed as disclosed in Japanese Unexamined Patent Application Publication No. 2007-201779.

However, in a technique disclosed in the Japanese Unexamined Patent Application Publication No. 2007-201779, the continuous shooting speed is set to be rapid even if a moving speed of a subject is slow, as long as the angle of view is small. As a result, a large number of images, in which changes of the subject are little, come to be stored as continuous shots.

In this case, continuous shots by which changes of the subject is understandable can be obtained by selecting images from the stored continuous shots at every some number of images and deleting the other images, by a user. However, a problem occurs in which judgment as to which image to chose to make the continuous shots be understandable is difficult and complicated.

### SUMMARY OF THE INVENTION

The present invention is directed to easily set a continuous shooting speed by which continuous shots desired by a user can be obtained.

According to a first aspect of the present invention, there is provided an imaging apparatus, including: an imaging section for generating image data by performing continuous shooting, a first setting section for setting the number of images to be photographed, in each of the images a subject image is to be included; a dividing section for dividing a photographing region of the imaging section into divided regions of the number of images set by the first setting section; a second setting section for setting a continuous shooting speed based on a photographed position of the subject image in each of the divided regions divided by the dividing section; and a controller for controlling the imaging section to perform the continuous shooting at the continuous shooting speed set by the second setting section.

According to a second aspect of the present invention, there is provided a method for setting continuous shooting speed, the method including the steps of: (a) setting the number of images to be photographed, in each of the images a subject image is to be included; (b) dividing a photographing region into divided regions of the number of images set in step (a); and (c) setting a continuous shooting speed based on a photographed position of the subject image in each of the divided regions divided in step (b).

According to a third aspect of the present invention, there is provided a storage medium for storing a program causing a computer to function as: an imaging section for generating image data by performing continuous shooting, a first setting section for setting the number of images to be photographed, in each of the images a subject image is to be included; a dividing section for dividing a photographing region of the imaging section into divided regions of the number of images set by the first setting section; a second setting section for setting a continuous shooting speed based on a photographed position of the subject image in each of the divided regions divided by the dividing section; and a controller for controlling the imaging section to perform the continuous shooting at the continuous shooting speed set by the second setting section.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a block diagram showing a functional configuration of an imaging apparatus according to an embodiment of the present invention;

FIG. 2 is a flowchart showing a process executed by the imaging apparatus;

FIG. 3 is a diagram showing an example of a frame for dividing a photographing region;

FIG. 4A is a diagram showing a part of images obtained by the continuous shooting;

FIG. 4B is a diagram showing a part of images obtained by the continuous shooting;

FIG. 4C is a diagram showing a part of images obtained by the continuous shooting;

FIG. 4D is a diagram showing a part of images obtained by the continuous shooting;

FIG. 4E is a diagram showing a part of images obtained by the continuous shooting;

FIG. 4F is a diagram showing a part of images obtained by the continuous shooting;

FIG. 4G is a diagram showing a part of images obtained by the continuous shooting;

FIG. 4H is a diagram showing a part of images obtained by the continuous shooting;

FIG. 4I is a diagram showing a part of images obtained by the continuous shooting; and

FIG. 4J is a diagram showing a part of images obtained by the continuous shooting.

### DETAILED DESCRIPTION OF THE PREFERRED EMBODIMENTS

In the following, an imaging apparatus, a method for setting a continuous shooting speed and a storage medium according to an embodiment of the present invention will be described with reference to the attached drawings.

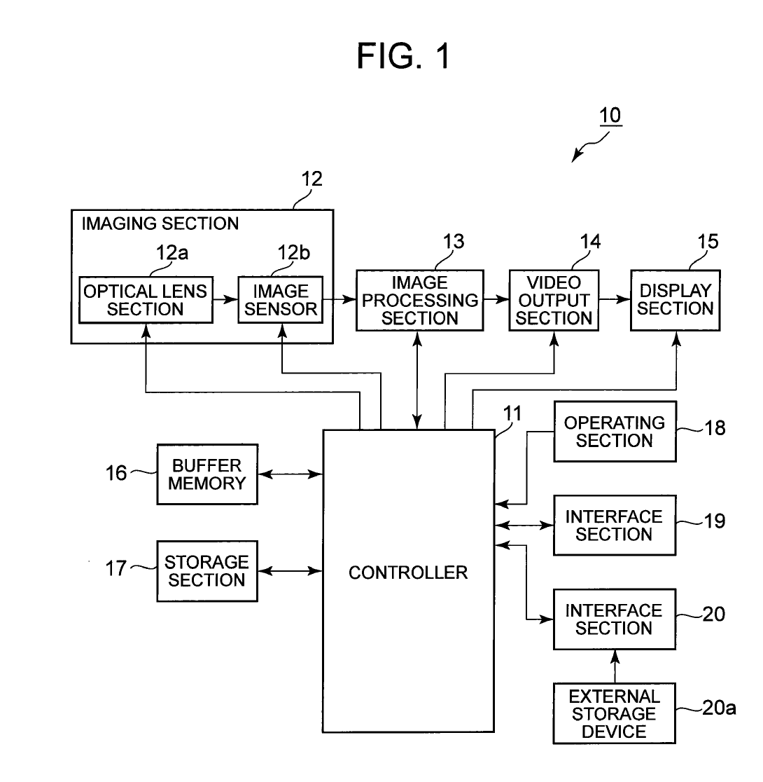

As shown in FIG. 1, an imaging apparatus 10 includes a controller 11, an imaging section 12, an image processing section 13, a video output section 14, a display section 15, a buffer memory 16, a storage section 17, an operating section 18, and interface sections 19 and 20.

The controller 11 includes a Central Processing Unit (CPU), a Random Access Memory (RAM), and the like. The controller 11 cooperates with a program stored in the storage section 17 to perform various calculations and centrally controls performances of each part of the imaging apparatus 10 in order to execute various processing.

For example, the controller 11 calculates a travel distance or diaphragm amount of lens included in an optical lens section 12a based on a detection signal detected by a ranging sensor, a light amount sensor, or the like, which are not shown. Then, the controller 11 controls a lens driver and diaphragm amount to perform focusing (focus slide) or zooming. Moreover, the controller 11 controls timing to readout a photographed signal from an image sensor 12b.

Moreover, the controller 11 executes processing for setting continuous shooting speed at the time of continuous shooting. In this processing, the controller 11 (first setting section) sets, corresponding to an assignment operation by the user, the number of images, in each of which a subject image is to be included by the continuous shooting. Then, the controller 11 (dividing section) divides a photographing region into divided regions of the set number of images. The controller 11 causes the imaging section 12 to execute continuous shooting at a predetermined continuous shooting speed, and calculates a continuous shooting speed based on photographed positions of the subject image included in each of the divided regions, for an obtained plurality of images. The controller 11 (second setting section) sets a continuous shooting speed to the continuous shooting speed calculated as a continuous shooting speed at the time of executing the continuous shooting, and controls the imaging section 12 to execute the continuous shooting at the set continuous shooting speed. That is, a first setting section, a dividing section, a second setting section and a controller can be realized by the controller 11.

The imaging section 12 includes the optical lens section 12a and the image sensor 12b, and functions as an imaging section for performing the photographing. The optical lens section 12a includes a focusing lens, a zoom lens, a diaphragm shutter or the like, and captures optical image of a subject to form an image at the image sensor 12b. The image sensor 12b includes a photoelectric conversion element such as a Charge Coupled Device (CCD) or a Complementary Metal-Oxide Semiconductor (CMOS), or the like. The image sensor 12b photographs a subject image, which is formed on an imaging area of the image sensor 12b through the optical lens section 12a, and outputs an analog signal.

The image processing section 13 performs digital conversion to the analog signal input from the imaging section 12. The image processing section 13 performs a signal processing such as a color interpolation processing to a photographed signal converted into a digital form, and generates image data in a predetermined format.

The video output section 14 converts the image data, which is input from the image processing section 13, to a display signal, and outputs the display signal to the output section 15.

The output section 15 includes a display such as a Liquid Crystal Display (LCD) and displays an image on a display screen according to an instruction included in the display signal input from the video output section 14.

The buffer memory 16 is a memory for temporarily storing the image data of a photographed image.

The storage section 17 stores files or parameters needed for executing programs or processing used by the controller 11. Also, the storage section 17 is a memory for storing the photographed image.

A semiconductor memory can be applied as the buffer memory 16 or the storage section 17.

The operating section 18 includes operation keys such as a shutter key, a numeric keypad, a menu key, an arrow key, an enter key, or the like. The operating section 18 outputs an operation signal, which corresponds to a key that is operated, to the controller 11.

The interface section 19 sends and receives data with an external apparatus such as a personal computer or a printer through a wire communication, an infrared communication, a wireless communication, or the like. A Universal Serial Bus (USB) or an Institute of Electrical and Electronic Engineers 1394 (IEEE1394) can be applied as the wire communication, and a Bluetooth™ can be applied as the wireless communication.

The interface section 20 inputs and outputs data from/to an external storage device 20a. The external storage device 20a is a detachable memory such as, for example, a Compact Flash (CF) card, an SD card, a USB memory or the like. The external storage device 20a can be used as a memory for storing images.

Next, a performance of the imaging apparatus 10 will be explained.

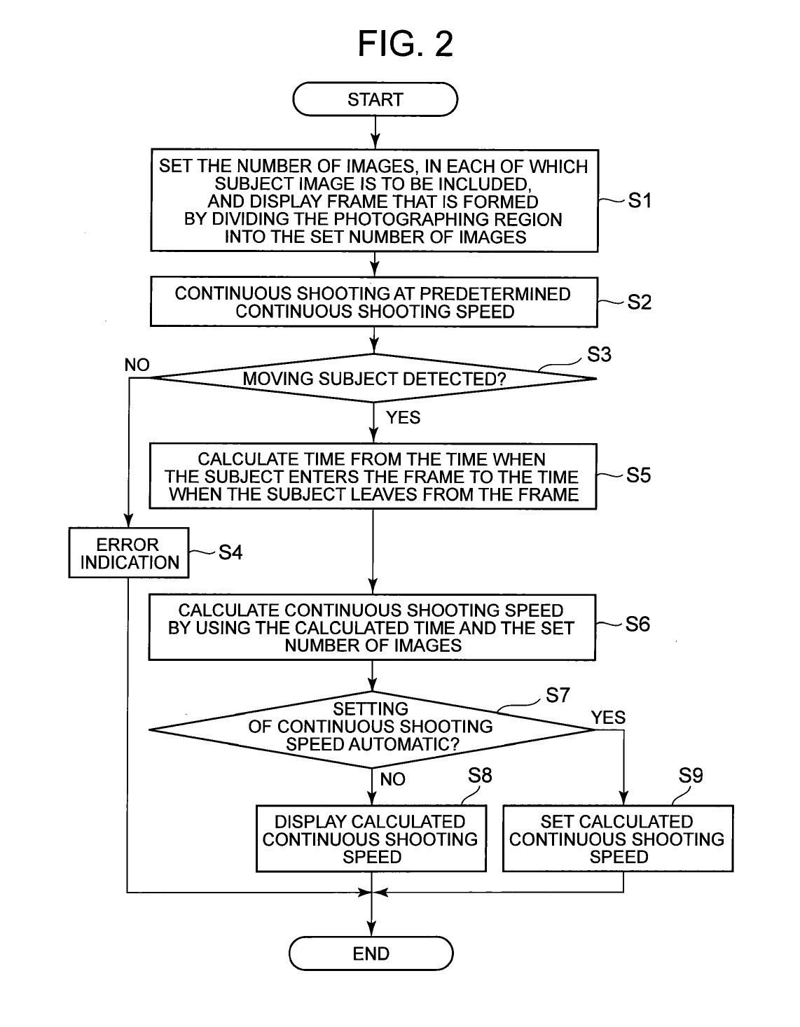

FIG. 2 shows a flow of the processing executed by the imaging apparatus 10 when setting a continuous shooting speed. In this processing, by specifying, by the user, the number of images to be photographed, to be stored, and to include a subject image of a moving subject when continuously shooting the moving subject, the continuous shooting speed can be set so that a photographed position of the subject in each of the images obtained by the continuous shooting changes corresponding to the specified number of images.

The imaging apparatus 10 provides a shooting mode for continuously shooting the moving subject. When the shooting mode is selected, the controller 11 causes the display section 15 to display an operation screen by which the user can set the number of images to be photographed, to be stored and to include the subject image therein. The user inputs the number of images through the operation screen. The number of images input by the user represents serial shoot duration at a time of photographing the moving subject, which moves around within a frame (photographing region). That is, the user only sets the number of images which the user wants to photograph from the time when the subject enters the frame to the time when the subject leaves from the frame.

As shown in FIG. 2, the controller 11 of the imaging apparatus 10 sets the number of images assigned by the user as the number of images in which the subject image is to be included among a plurality of images obtained by the continuous shooting. Then, the controller 11 causes the display section 15 to display on the display section 15 a frame (borderline or pane) for dividing the photographing region of the imaging section 12 into the set number of images (step S1). At the display section 15, a live view display mode is undergoing, therefore the frame is displayed on the image that is displayed on the display section 15 under the live view display mode. Here, the term “live view display” represents displaying the images, which are obtained by the imaging section 12, without being stored in the storage section 17.

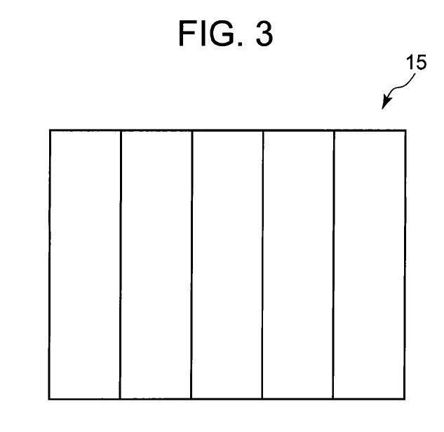

For example, if the number of images is set to be five, then, as shown in FIG. 3, a frame, which divides the photographing region into five, is displayed. By displaying such a frame, the user easily recognizes photographing positions of the moving subject moving around within the frame, and the user easily determine the timing of operating the shutter key (shutter button).

Next, when the shutter key is operated by the user, the controller 11 causes the imaging section 12 to start the continuous shooting at a predetermined continuous shooting speed (step S2). For example, the controller 11 causes the imaging section 12 to perform continuous shooting at a continuous shooting speed of 40 frames per second (fps) for one sec. The continuous shots composed of images obtained by the continuous shooting are temporarily stored in the buffer memory 16.

Next, the controller 11 readouts each of the stored images from the buffer memory 16, and performs a moving subject detection (step S3). Although, lots of commonly-known techniques are presented as a method for detecting the moving subject, a method of judging whether the moving subject exists or not by a difference image obtained by continuous images is adopted in the present embodiment, for the reason that, if continuously shoots the moving subject, a background changes a little between images, each photographed time of which are close. Here, the moving subject detection is carried out by using thumbnail images that are reduced in size to a size for displaying or the like, but not by using the images themselves as photographed. By using the thumbnail images, processing time for processing the moving subject detection can be shortened.

If the moving subject is not detected (step S3: No), the controller 11 causes the display section 15 to display an error indication on the display section 15 to notify the user that an adequate continuous shooting speed could not be set as to continuously shooting the moving subject because the moving subject was not detected (step S4), then finishes the process.

If the moving subject is detected (step S3: Yes), the controller 11 calculates photographed time of the image, in which photographed position of the subject image is included in one of the divided region, among the plurality of images obtained by the imaging section 12. That is, the controller 11 calculates the time from when the subject, which is detected as the moving subject in each of the images, enters the frame to when the subject leaves from the frame (step S5).

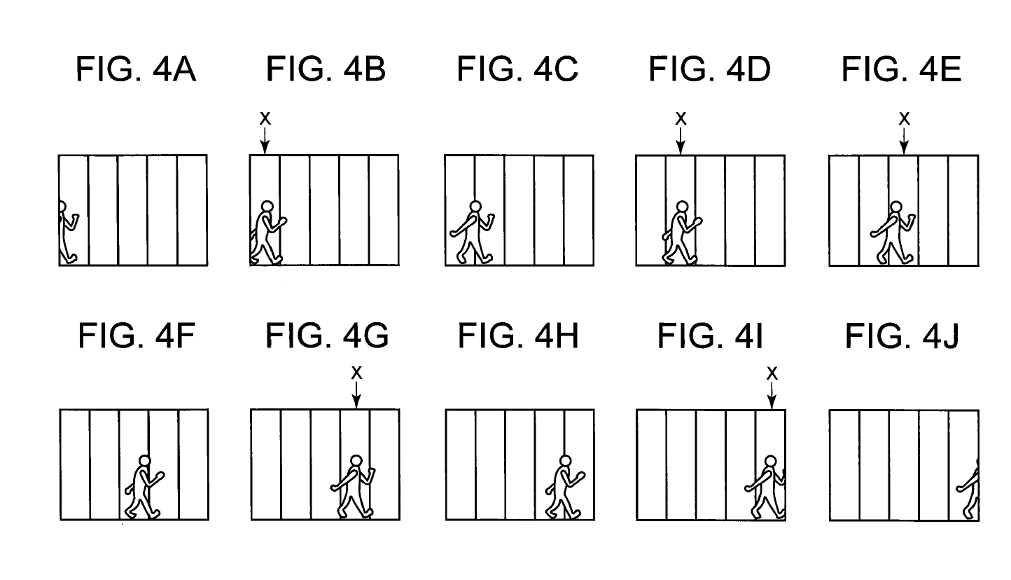

A calculating process in the above step S5 will be described in detail with reference to FIGS. 4A-4J. FIGS. 4A-4J show ten images that are photographed at 0.025 (sec) intervals after starting the photographing. FIG. 4A shows an image shot 0.075 (sec) after the start of the photographing; FIG. 4B shows an image shot 0.1 (sec) after the start of the photographing; FIG. 4C shows an image shot 0.125 (sec) after the start of the photographing . . . .

The controller 11 judges that the image shown in FIG. 4B, that is the image shot t=0.1 (sec) after the start of the photographing, as an image in which a subject X enters the frame, and judges that the image shown in FIG. 4I, that is the image shot t=0.275 (sec) after the start of the photographing, as an image in which the subject X leaves from the frame, by referring to the images. Then, the controller 11 calculates 0.275 (sec)−0,100 (sec)=0.175 (sec) as the time from when the subject enters the frame to when the subject leaves from the frame.

Then, the controller 11 calculates a continuous shooting speed (fps) by the following formula using the time calculated at step S5 and the number of images set in step S1 (step S6).

fps=(number of images)/(time from when the subject enters the frame to when the subject leaves from the frame)

In an example shown in FIGS. 4A-4J, images, in which the subject image is positioned at the nearest to the center of each of the five divided regions, are the five images composed of the image shown in FIG. 4B shot t=0.100 (sec) after the start of the photographing, the image shown in FIG. 4D shot t=0.150 (sec) after the start of the photographing, the image shown in FIG. 4E shot t=0.175 (sec) after the start of the photographing, the image shown in FIG. 4G shot t=0.225 (sec) after the start of the photographing, and the image shown in FIG. 4I shot t=0.275 (sec) after the start of the photographing. Therefore, continuous shots, in which the photographed positions of the subject is respectively located in the five divided regions, can be obtained as long as the continuous shooting speed satisfies the condition that at least the five images can be photographed during a period of time from when the subject enters the frame to when the subject leaves from the frame.

Therefore, the controller 11 calculates the continuous shooting speed (fps) by using the time from when the subject enters the frame to when the subject leaves from the frame as shown in the above formula, that is, the time when the image that actually includes the subject image is photographed. If the moving speed of the subject is fast, the time from when the subject enters the frame to when the subject leaves from the frame is short, thus the continuous shooting speed calculated to obtain the set number of images becomes fast. On the contrary, if the moving speed of the subject is slow, the continuous shooting speed becomes slow. That is, a continuous shooting speed, which corresponds to the moving speed of the subject from when the subject enters the frame to when the subject leaves from the frame, can be calculated.

When the continuous shooting speed is calculated, the controller 11 judges whether the setting of the continuous shooting speed is set to automatic or not (step S7). If the setting of the continuous shooting speed is preliminarily set to automatic by the user (step S7; Yes), the controller 11 sets the calculated continuous shooting speed as a continuous shooting speed of the continuous shooting (step S9), then finishes the process. By this setting in step S9, the controller 11 controls the imaging section 12 so that photographing at the imaging section 12 would be executed at the set continuous shooting speed when in the continuous shooting that follows.

On the other hand, if the setting of the continuous shooting speed is not set to automatic (step S7; No), the controller 11 causes the display section 15 to display the calculated continuous shooting speed on the display section 15 (step S8), and then finishes the process. The user who checked the displayed continuous shooting speed can understand an appropriate continuous shooting speed at the time of the last continuous shooting. If the user wants to set the continuous shooting speed to the displayed continuous shooting speed, the user can manually set the continuous shooting speed.

As described above, according to the embodiment of the present invention, the controller 11 sets the number of images in which the subject image is to be included, within the continuous shots obtained by the continuous shooting, and divides photographing region of the imaging section 12 by using the set number of images. Moreover, the controller 11 analyzes each of the images that are actually obtained by the continuous shooting, calculates the time from when the subject enters the frame to when the subject leaves from the frame, then calculates the continuous shooting speed by using the calculated time and the set number of images. That is, since the controller 11 sets the continuous shooting speed based on photographed position of the subject image so that images, in which the subject image is included in the divided regions, respectively, can be obtained, the user can easily set a continuous shooting speed that corresponds to the moving speed of the subject.

The above embodiment is only a preferred example of the present invention, thus should not be limited to the above.

For example, although the moving subject is assumed to be an object for the continuous shooting in the above embodiment, a subject changeable in size may be applied as the object for the continuous shooting when setting the continuous shooting speed. Moreover, although the divided region obtained by longitudinally dividing the photographing region into five is shown as an example in the above embodiment, the divided region may be obtained by dividing the photographing region in quarters, for example, dividing the photographing region longitudinally and crosswise into two, respectively, or may be divided into four by dividing the photographing region using diagonal lines thereof. How to divide the photographing region may be arbitrarily set considering a moving direction of the subject.

The entire disclosure of Japanese Patent Application No. 2009-030714 filed on Feb. 13, 2009 including description, claims, drawings, and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. An imaging apparatus, comprising:
an imaging section for generating image data by performing continuous shooting,
a first setting section for setting the number of images to be photographed, in each of the images a subject image is to be included;
a dividing section for dividing a photographing region of the imaging section into divided regions of the number of images set by the first setting section;
a second setting section for setting a continuous shooting speed based on a photographed position of the subject image in each of the divided regions divided by the dividing section; and
a controller for controlling the imaging section to perform the continuous shooting at the continuous shooting speed set by the second setting section.

2. The imaging apparatus of claim 1, wherein
the second setting section causes the imaging section to perform the continuous shooting in order to calculate a time at which the image, in which the photographed position of the subject image is included in one of the divided regions, is photographed, and sets the continuous shooting speed by using the calculated time and the number of images set by the first setting section.

3. The imaging apparatus of claim 1, wherein
the second setting section judges the photographed position of the subject image by using a thumbnail image of the image obtained by the continuous shooting.

4. A method for setting continuous shooting speed, the method comprising the steps of:
(a) setting the number of images to be photographed, in each of the images a subject image is to be included;
(b) dividing a photographing region into divided regions of the number of images set in step (a); and
(c) setting a continuous shooting speed based on a photographed position of the subject image in each of the divided regions divided in step (b).

5. A storage medium for storing a program causing a computer to function as:
an imaging section for generating image data by performing continuous shooting,
a first setting section for setting the number of images to be photographed, in each of the images a subject image is to be included;
a dividing section for dividing a photographing region of the imaging section into divided regions of the number of images set by the first setting section;
a second setting section for setting a continuous shooting speed based on a photographed position of the subject image in each of the divided regions divided by the dividing section; and
a controller for controlling the imaging section to perform the continuous shooting at the continuous shooting speed set by the second setting section.
